(19) United States
(12) Patent Application Publication
(10) Pub. No.: US 2023/0013470 A1
(43) Pub. Date: Jan. 19, 2023

(54) AUTONOMIC DETECTION AND CORRECTION OF ARTIFICIAL INTELLIGENCE MODEL DRIFT

(71) Applicant: DELL PRODUCTS L.P., Round Rock, TX (US)

(72) Inventors: Said Tabet, Austin, TX (US); William Jeffery White, Plano, TX (US); George Currie, Austin, TX (US); Xin Ma, Pflugerville, TX (US)

(73) Assignee: DELL PRODUCTS L.P., Round Rock, TX (US)

(21) Appl. No.: 17/378,844

(22) Filed: Jul. 19, 2021

(51) Int. Cl. G06N 3/08; G06K 9/62

(52) U.S. Cl. CPC G06N 3/08; G06K 9/6256; G06K 9/6262

(57) ABSTRACT

A system for processing data is disclosed that includes an artificial intelligence (AI) model operating on a processor and configured to process an incoming data set to generate a data output. An AI model anomaly detection system operating on the processor and configured to receive the incoming data set and the data output and to generate an anomaly detection as a function of the incoming data set and the data output. An AI model anomaly analysis system operating on the processor and configured to receive the anomaly detection and the incoming data set and to generate AI model anomaly data. An AI model anomaly mitigation system operating on the processor and configured to receive the AI model anomaly data and to generate AI model anomaly correction data.

### TECHNICAL FIELD

The present disclosure relates generally to data processing, and more specifically to a system and method for autonomic detection and correction of artificial intelligence (AI) model drift.

### BACKGROUND OF THE INVENTION

AI models can suffer from problems where the output is unrelated to the input. For example, it is known that AI models can receive input data sets of noise and can improperly identify the noise as a picture of a baboon. Such problems typically must be resolved manually.

### SUMMARY OF THE INVENTION

A system for processing data is disclosed that includes an artificial intelligence (AI) model operating on a processor and configured to process an incoming data set to generate a data output. The system further includes an AI model anomaly detection system operating on the processor that is configured to receive the incoming data set and the data output and to generate an anomaly detection as a function of the incoming data set and the data output. An AI model anomaly analysis system operating on the processor is configured to receive the anomaly detection and the incoming data set and to generate AI model anomaly data. An AI model anomaly mitigation system operating on the processor is configured to receive the AI model anomaly data and to generate AI model anomaly correction data.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings may be to scale, but emphasis is placed upon clearly illustrating the principles of the present disclosure. Moreover, in the drawings, like reference numerals designate corresponding parts throughout the several views, and in which:

FIG. 1 is a diagram of an algorithm for assessing the drift of data for an AI model, in accordance with an example embodiment of the present disclosure;

FIG. 2 is a diagram of an algorithm for determining intrinsic and extrinsic characteristics of AI model data for drift analysis, in accordance with an example embodiment of the present disclosure;

FIG. 3 is a diagram of an algorithm for automated training and validation set identification for drift analysis, in accordance with an example embodiment of the present disclosure;

FIG. 4 is a diagram of a system for AI service management for drift analysis, in accordance with an example embodiment of the present disclosure;

FIG. 5 is a system for drift analysis, in accordance with an example embodiment of the present disclosure;

FIG. 6 is a system for anomaly detection for drift analysis, in accordance with an example embodiment of the present disclosure;

FIG. 7 is a system for anomaly mitigation for drift analysis, in accordance with an example embodiment of the present disclosure; and

FIG. 8 is a system for anomaly analysis for drift analysis, in accordance with an example embodiment of the present disclosure.

### DETAILED DESCRIPTION OF THE INVENTION

In the description that follows, like parts are marked throughout the specification and drawings with the same reference numerals. The drawing figures may be to scale and certain components can be shown in generalized or schematic form and identified by commercial designations in the interest of clarity and conciseness.

The present disclosure is directed to autonomic detection and correction of AI model drift. The occurrence of AI model drift can be identified utilizing an unsupervised approach in which the data feeding the AI model is analyzed and/or the metrics of the AI model is analyzed. In either approach, once drift is detected, the data which induced the drift is analyzed to create a set of rich metadata to identify characteristics of the drift-inducing data. This metadata is then compared to the broader data set to identify appropriate data to retrain models experiencing drift. Once retrained, the AI models are then tested against multiple datasets to validate the desired level of AI model performance.

AI and machine learning (ML) design and development often focuses on the training and inferencing aspects and the efforts involved. Success factors for such projects can include dealing with the complexity of the data that is used to create or train the AI/ML. Large amounts of data are used for that purpose, and often requires substantial preparation and validation. This training data can impact the performance of the deployed algorithms. Drift in AI models is used to address the issue of degrading performance resulting from the training data, as it can have serious repercussions on workloads especially with mission critical deployments.

The present disclosure is directed to autonomic detection and correction of AI model drift, by analyzing the data feeding the AI model and/or the metrics of the AI model itself. In either approach, once drift is detected, the data which induced the drift is analyzed to create a set of rich metadata to identify characteristics of the drift inducing data. This metadata is then compared to the broader data set to identify appropriate data to retrain models experiencing drift. Once retrained, the AI models are then tested against multiple datasets to validate the desired level of AI model performance.

As the number and complexity of AI models grows, the need to monitor the performance of those models becomes increasingly difficult and resource intensive. Current methods require a significant amount of skilled human intervention to accomplish that goal, which limits the number of models that can be effectively monitored, the efficacy of monitoring, and the number of models that can be corrected. There are principally two types of drift. Data drift is where the data presented to the inference model has changed from the training set and therefore is impacting the inference probability of object detection to change. Concept drift is where the data remains the same, however, its semantic meaning changes, causing a failure in object recognition or a misinterpretation. For certain types of AI models, this drift can be very pronounced, and performance can deteriorate rapidly.

Data identification using data characteristics is a critical capability to enable the automation of multiple tasks in the AI model lifecycle. The characteristics of a particular item of data can be derived from many sources and as a whole allow for the creation of rich relationships between different pieces of data. One source of characteristics are those derived from the data item as an object, without regards for the file type or contents. For example “creation time,” “size in bytes,” and other characteristics can be obtained from the data in regards to its object characteristics. Another source of characteristics can be obtained from the “type” of file. For example, an image data file can have associated characteristics for “encoding,” “dimensions,” and so forth. Another source of characteristics can be obtained from the actual contents of the file itself. For example, a text file containing a chat transcript can be analyzed to extract named entities, derive sentiment, and so forth. Another source of characteristics can be obtained from information that can be derived from leveraging any of the previous sources to act as information to reference a completely external source. For example, the time and location of surveillance footage of an area can be used to correlate police report data. These sources are provided as an example and are not intended to be exhaustive.

Existing drift detection techniques may require that the data being used as input to a model has the “ground truth” labels associated with the data. This ground truth data is then compared to the actual output of the model and discrepancies between the two data sets can be used to identify possible model drift. While annotated ground truth labels may be available in certain limited datasets, models that work upon general real-world data will typically not have ground truth labels associated with them. It is therefore preferable to utilize model drift detection techniques that are not dependent on having ground truth labels.

Once model drift is detected, the factors in the drift inducing dataset can be identified that are the primary cause for the drift. This can be accomplished by examination of the drift inducing dataset to discern which factors may be those drift inducers. This process is time consuming and its efficacy is highly dependent on the skill level of the person performing the analysis, when it is done manually.

Once drift inducing factors have been identified, a broader dataset that contains similar characteristics as the drift inducing dataset typically can be utilized to effectively retrain the AI model. Current systems typically do not address this aspect of training set identification at all, leaving this to be a manual task.

The present disclosure provides systems and methods that allow for the fully automated lifecycle management of an AI model that is being negatively influenced by model drift. Data coming into the system is automatically tagged by one or more special purpose processors to analyze the incoming data and assign metadata tags based on the outcomes of the analysis. Once tagged, a pre-model drift analysis is performed to analyze the incoming data, such as by using one or more unsupervised techniques to identify data that is likely to cause model drift or in other suitable manners. Regardless of the outcome of the analysis, the data is then allowed to run through the AI model. Post-model drift analysis can then be performed on the model predictions to determine if drift has occurred. This drift detection process can be performed by statistical analysis of object detection and object recognition rates and performing statistical tests to determine if the model process is in statistically stationary operation. The model can be treated as a stochastic process and analyzed mathematically to determine effectiveness of operation. If the model begins to depart from stationary operation, it can be identified as being potentially impacted by drift.

The present disclosure leverages pre-model or post-model analysis to identify possible drift, and one or more drift factor analyzers can be utilized to identify specific characteristics of either the incoming dataset or the observed model output to identify specific drift inducing aspects if drift might be occurring. Once any drift inducing aspects have been identified, the global dataset can then be automatically queried to identify a suitable training set to correct the AI model and the AI model can then be re-trained.

In one example embodiment, the present disclosure approaches drift detection using an ensemble approach rather than a monolithic task. First, the incoming dataset can be analyzed for variances from a determined norm. This determined norm can be established by identifying data for which no drift was identified and whose model performance is identified as having a high level of quality. Secondly, the predictions made by the model on the dataset can be analyzed against a determined norm for prediction results. Once both pre- and post-model analysis is complete, an overall determination of the presence of model drift can be calculated.

In another example embodiment, once model drift has been detected, the characteristics of the dataset that instigated the drift can be utilized to identify data from the broader dataset that contains similar characteristics. Other static characteristics can also be utilized, such as whether the dataset is the newest data and so forth.

In another example embodiment, intrinsic characteristics can be explicitly observed in either the dataset that is provided to the model, based on the predictions of the model or in other suitable manners. This approach introduces the notion of “extrinsic” characteristics that are based on information inferred or referenced based on intrinsic characteristics. For example, the weather conditions at a GPS location (intrinsic) at a particular time (intrinsic) can be queried via a third-party source (such as the National Weather Service) to determine the weather conditions at the time and location. These extrinsic characteristics can provide additional insights into conditions that can potentially affect model performance but which are not ascertainable directly from the data itself.

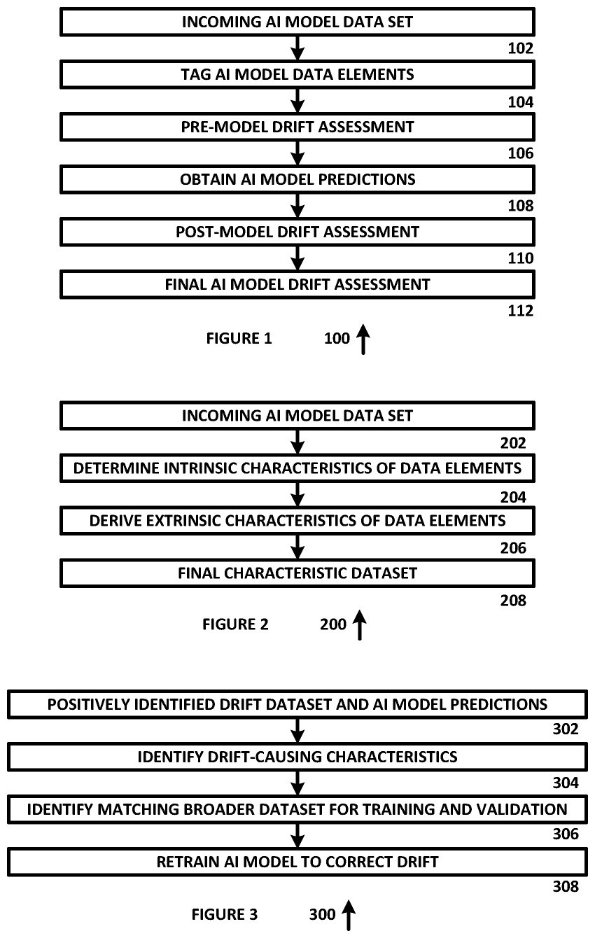

FIG. 1 is a diagram of an algorithm 100 for assessing the drift of data for an AI model, in accordance with an example embodiment of the present disclosure. Algorithm 100 can be implemented in hardware or a suitable combination of hardware and software.

Algorithm 100 begins at 102, where an incoming data set is received. In one example embodiment, the incoming data set can be periodically received, such as by generating image data in a moving vehicle or in other suitable manners. The algorithm then proceeds to 104.

At 104, data items in the incoming data set is tagged by a processor that has been configured to tag the data items for drift analysis based on one or more algorithmic processes that identify tags from the data item as an object, the type of file associated with the data item, the contents of the file, from external sources or in other suitable manners that can allow the tags to be used for drift analysis. The algorithm then proceeds to 106.

At 106, a pre-model drift assessment is performed by a processor that has been configured to identify tagged data that is associated with drift, such as by comparing variations in the tagged data with variations in the data that was used to create an AI model or in other suitable manners. The algorithm then proceeds to 108.

At 108, model predictions are obtained by a processor that has been configured to determine the expected results from processing the incoming data set. In one example, embodiment, when the tagged data is determined to have one or more characteristics that fall outside of an expected range, a prediction on the outcome of processing the incoming data set with the AI model can be determined, such as a “pass” or “fail” prediction, a “drift” or “no-drift” prediction or other suitable predictions. The algorithm then proceeds to 110.

At 110, a post model drift assessment is performed, such as by a processor that has been configured to compare the results of processing of the incoming data set by the AI model with the predicted results or in other suitable manners. The algorithm then proceeds to 112.

At 112, a final drift assessment is performed, such as by a processor that has been configured to obtain verification of drift of the incoming data set from one or more additional sources or in other suitable manners. The algorithm then terminates.

In operation, algorithm 100 allows drift of an incoming data set for an AI model to be assessed. While algorithm 100 is shown as a flow chart, a person of skill in the art will recognize that algorithm 100 can also or alternatively be implemented using object oriented programming, state diagrams, ladder diagrams or in other suitable manners.

FIG. 2 is a diagram of an algorithm 200 for determining intrinsic and extrinsic characteristics of AI model data for drift analysis, in accordance with an example embodiment of the present disclosure. Algorithm 200 can be implemented in hardware or a suitable combination of hardware and software.

Algorithm 200 begins at 202, where an incoming data set is received. In one example embodiment, the incoming data set can be periodically received, such as by generating image data in a moving vehicle or in other suitable manners. The algorithm then proceeds to 204.

At 204, intrinsic characteristics of the incoming data set are determined. In one example embodiment, a processor can be used to process the incoming data set, where the processor has been configured using one or more algorithms to identify intrinsic characteristics of the incoming data set based on one or more algorithmic processes that identify data items of the incoming data set as objects, the type of file associated with the data item or the incoming data set, the contents of the file or the incoming data set, external sources associated with the incoming data set or in other suitable manners. The algorithm then proceeds to 206.

At 206, extrinsic characteristics of the incoming data set are derived. In one example embodiment, a processor can be used to process the incoming data set and the intrinsic characteristics of the incoming data set to obtain extrinsic data from an external source, such as based on one or more algorithmic processes that identify relevant external sources based on the incoming data set and the intrinsic data or in other suitable manners. The algorithm then proceeds to 208.

At 208, a final characteristic data set is obtained. In one example embodiment, the intrinsic and extrinsic data sets can be combined with the incoming data set or other suitable processes can also or alternatively be used. The algorithm then terminates.

In operation, algorithm 200 allows intrinsic and extrinsic characteristics of AI model data to be determined for use in drift analysis. While algorithm 200 is shown as a flow chart, a person of skill in the art will recognize that algorithm 200 can also or alternatively be implemented using object oriented programming, state diagrams, ladder diagrams or in other suitable manners.

FIG. 3 is a diagram of an algorithm 300 for automated training and validation set identification for drift analysis, in accordance with an example embodiment of the present disclosure. Algorithm 200 can be implemented in hardware or a suitable combination of hardware and software.

Algorithm 300 begins at 302, where a positively identified drift data set and model predictions are created. In one example embodiment, the data set and model predictions can be stored in a database to allow the data set to be processed to determine whether the model predictions are accurate or for other suitable purposes. The algorithm then proceeds to 304.

At 304, drift-causing characteristics of the data set are identified. In one example embodiment, tagged data can be analyzed and compared with tagged data of other data sets that experienced drift, tagged data of other data sets that did not experience drift or other suitable data, such as to identify subsets of data that can be monitored to detect drift or potential drift. The algorithm then proceeds to 306.

At 306, matching broader data sets are identified for training and validation. In one example embodiment, data sets can be used to improve an AI model, can be used to select an appropriate AI model, or for other suitable purposes associated with AI model training and validation to avoid drift in AI model processing of data sets. The algorithm then proceeds to 308.

At 308, the AI model is retrained to improve the ability to detect, correct and/or prevent drift. In one example embodiment, the new AI model can be saved, a separate AI model can be created for use with specific data sets or other suitable processes can also or alternatively be used. The algorithm then terminates.

In operation, algorithm 300 allows for automated training and validation set identification for drift analysis associated with AI model processing. While algorithm 300 is shown as a flow chart, a person of skill in the art will recognize that algorithm 300 can also or alternatively be implemented using object oriented programming, state diagrams, ladder diagrams or in other suitable manners.

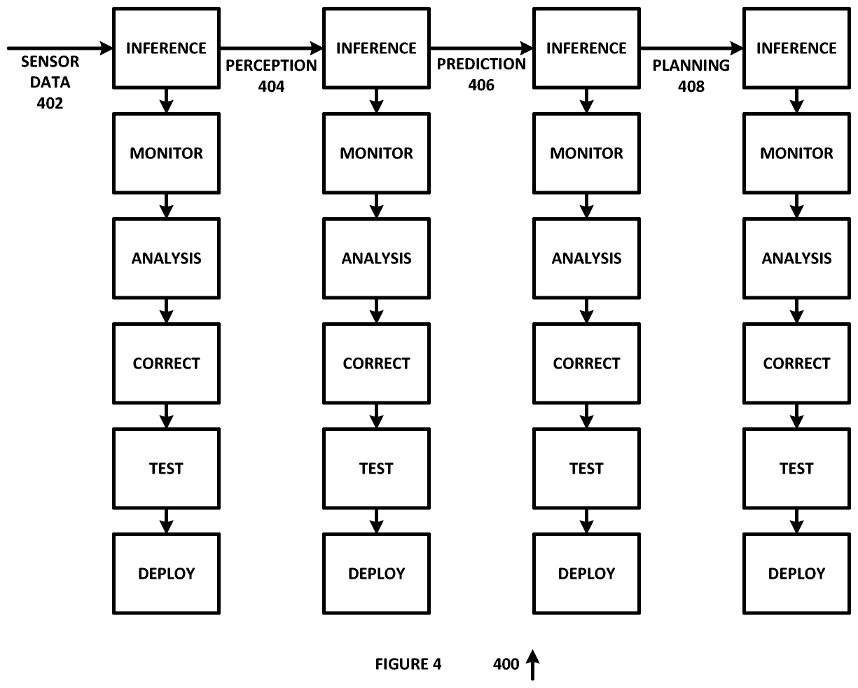

FIG. 4 is a diagram of a system 400 for AI service management for drift analysis, in accordance with an example embodiment of the present disclosure. System 400 includes sensor data processor 402, perception processor 404, prediction processor 406 and planning processor 408, each of which can be implemented in hardware or a suitable combination of hardware and software.

Sensor data processor 402 can be implemented as one or more algorithms loaded from a data memory device into working memory of a processor, which cause the processor to perform a series of processes for detecting drift in an AI model based on sensor data. In one example embodiment, the processes can include an inference process, such as where sensor data is processed to generate inference data. Sensor data processor 402 can further include a monitor process, where a functional safety layer monitors statistical properties of inference accuracy to detect non-stationary performance. Sensor data processor 402 can further include an analysis process, where data is acquired for analysis upon detection. Sensor data processor 402 can further include a correction process, where remediation action, relabel or algorithm, then retrain regimen, and human intervention. Sensor data processor 402 can further include a test process which can test and validate a new AI model. Sensor data processor 402 can further include a deployment process for use with sensor data, where a new AI model is submitted to inventory for deployment. Sensor data processor 402 can also or alternatively generate a data output for use by perception processor 404.

Perception processor 404 can be implemented as one or more algorithms loaded from a data memory device into working memory of a processor, which cause the processor to perform a series of processes for detecting drift in an AI model based on processed sensor data. In one example embodiment, the processes can include an inference process, a monitor process, an analysis process, a correction process, a test process and a deployment process for use with processed sensor data, each of which can be coordinated with associated processes of sensor data processor 402. Perception processor 404 can also or alternatively generate a data output for use by prediction processor 406.

Prediction processor 406 can be implemented as one or more algorithms loaded from a data memory device into working memory of a processor, which cause the processor to perform a series of processes for detecting drift in an AI model based on data output by perception processor 404. In one example embodiment, the processes can include an inference process, a monitor process, an analysis process, a correction process, a test process and a deployment process for use with sensor data, each of which can be coordinated with associated processes of sensor data processor 402 and perception processor 404. Prediction processor 406 can also or alternatively generate a data output for use by planning processor 408.

Planning processor 408 can be implemented as one or more algorithms loaded from a data memory device into working memory of a processor, which cause the processor to perform a series of processes for detecting drift in an AI model based on data output by prediction processor 406. In one example embodiment, the processes can include an inference process, a monitor process, an analysis process, a correction process, a test process and a deployment process for use with sensor data, each of which can be coordinated with associated processes of sensor data processor 402, perception processor 404 and prediction processor 406.

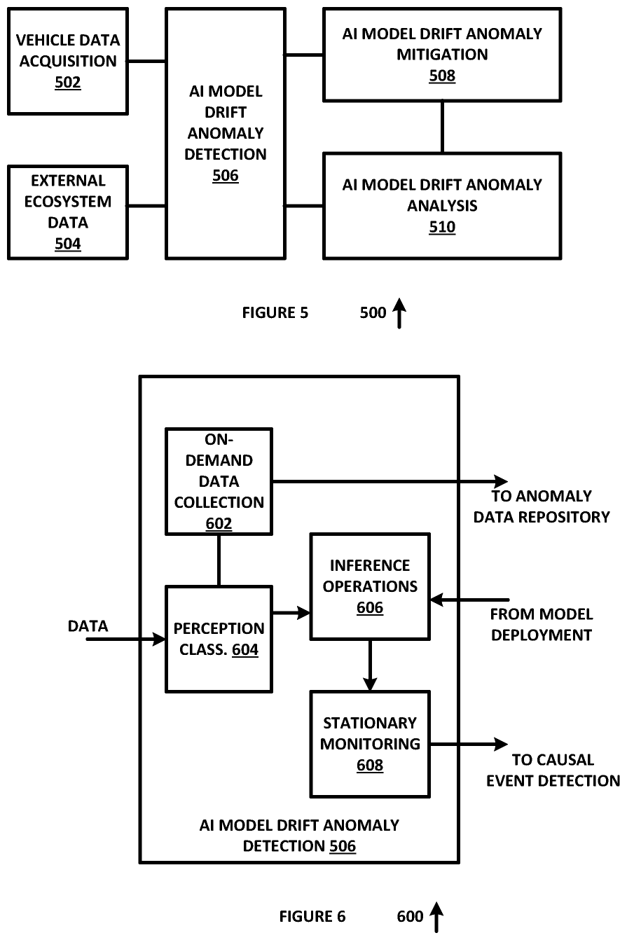

FIG. 5 is a system 500 for drift analysis, in accordance with an example embodiment of the present disclosure. System 500 includes vehicle data acquisition 502, external ecosystem data 504, anomaly detection 506, anomaly mitigation 508 and anomaly analysis 510, each of which can be implemented in hardware or a suitable combination of hardware and software.

Vehicle data acquisition 502 can be implemented as one or more algorithms loaded from a data memory device into working memory of a processor, which cause the processor to perform acquisition of vehicle data sets, such as a sequence of image data sets, control data sets, acceleration data sets, direction data sets or other suitable data sets. In one example embodiment, the data sets can include a plurality of data items such as data objects, data files or other suitable data structures. While vehicle data acquisition 502 is shown in this example embodiment, data acquisition for use with other AI models can also or alternatively be used, such as web browsing data acquisition, crowd monitoring data acquisition, financial transaction data acquisition or other suitable data acquisition.

External ecosystem data 504 can be implemented as one or more algorithms loaded from a data memory device into working memory of a processor, which cause the processor to perform acquisition of external ecosystem data, such as a sequence of image data from roadside cameras, weather data, data from other vehicles or other suitable data. In one example embodiment, the data sets can include a plurality of data items such as data objects, data files or other suitable data structures.

Anomaly detection 506 can be implemented as one or more algorithms loaded from a data memory device into working memory of a processor, which cause the processor to perform anomaly detection of data sets received from vehicle data acquisition 502 and external ecosystem data 504 and to generate data for use by anomaly mitigation 508 and anomaly analysis 510. In one example embodiment, anomaly detection 507 can receive feedback data from anomaly mitigation 508 and anomaly analysis 510 and can iteratively adjust the anomaly detection processing. In this example embodiment, anomaly detection 506 can detect a suspected anomaly based on data sets received from vehicle data acquisition 502 and external ecosystem data 504, and can provide the data to anomaly analysis 510 to determine whether the anomaly would result in drift in an AI model. If the anomaly does not result in drift, then anomaly detection 506 can be modified to improve the anomaly detection processing, but if drift would result, anomaly mitigation 508 can be used to determine mitigation processing for the anomaly, such as additional data sets that can be used to resolve the anomaly, different AI models that can be used to process the anomaly, training of AI models to address the anomaly or other suitable mitigation processing.

Anomaly mitigation 508 can be implemented as one or more algorithms loaded from a data memory device into working memory of a processor, which cause the processor to perform anomaly mitigation processing for data sets with identified anomalies, to prevent drift in AI model processing. In one example embodiment, anomaly mitigation 508 can identify additional processing for the data to mitigate the anomaly, such as data filtering, data processing or other suitable functions to be performed on the data to resolve the anomaly. In another example embodiment, anomaly mitigation 508 can select different AI models for use with the data set associated with the anomaly, can train an existing AI model to properly process the data set associated with the anomaly, or can perform other suitable processes.

Anomaly analysis 510 can be implemented as one or more algorithms loaded from a data memory device into working memory of a processor, which cause the processor to perform analysis of data sets associated with an anomaly to determine whether additional processing by anomaly mitigation 508 is needed, whether modification of anomaly detection 506 is needed, or other suitable processing. In one example embodiment, anomaly analysis 510 can identify whether drift will occur in an AI model using a data set and can implement corrective processes if drift occurs.

FIG. 6 is a system 600 for anomaly detection for drift analysis, in accordance with an example embodiment of the present disclosure. System 600 includes anomaly detection 506 and on-demand data collection 602, perception classification 604, inference operations 606 and stationary monitoring 608, each of which can be implemented in hardware or a suitable combination of hardware and software.

On-demand data collection 602 can be implemented as one or more algorithms loaded from a data memory device into working memory of a processor, which cause the processor to perform on-demand data processing for drift analysis and mitigation. In one example embodiment, on-demand data collection can be performed to obtain data from a vehicle data acquisition system, a non-vehicle data acquisition system, a web-based data acquisition system, a camera-based data acquisition system, a radar-based data acquisition system, a satellite-based data acquisition system or other suitable data acquisition systems.

Perception classification 604 can be implemented as one or more algorithms loaded from a data memory device into working memory of a processor, which cause the processor to perform perception classification processing on data, such as image data, audio data or other suitable data. In one example embodiment, perception classification 604 can continuously process data that is received from vehicle data acquisition 502, external ecosystem data 504 or other suitable sources.

Inference operations 606 can be implemented as one or more algorithms loaded from a data memory device into working memory of a processor, which cause the processor to perform inference processing on data received from perception classification 604, such as to generate inference data for stationary monitoring 608 or other suitable data. Inference operations 606 can receive model deployment data to implement a new AI model or other suitable data.

Stationary monitoring 608 can be implemented as one or more algorithms loaded from a data memory device into working memory of a processor, which cause the processor to perform stationary monitoring processing of data received from inference operations 606 or other suitable data. In one example embodiment, stationary monitoring 608 can generate an output for causal event detection or other suitable outputs.

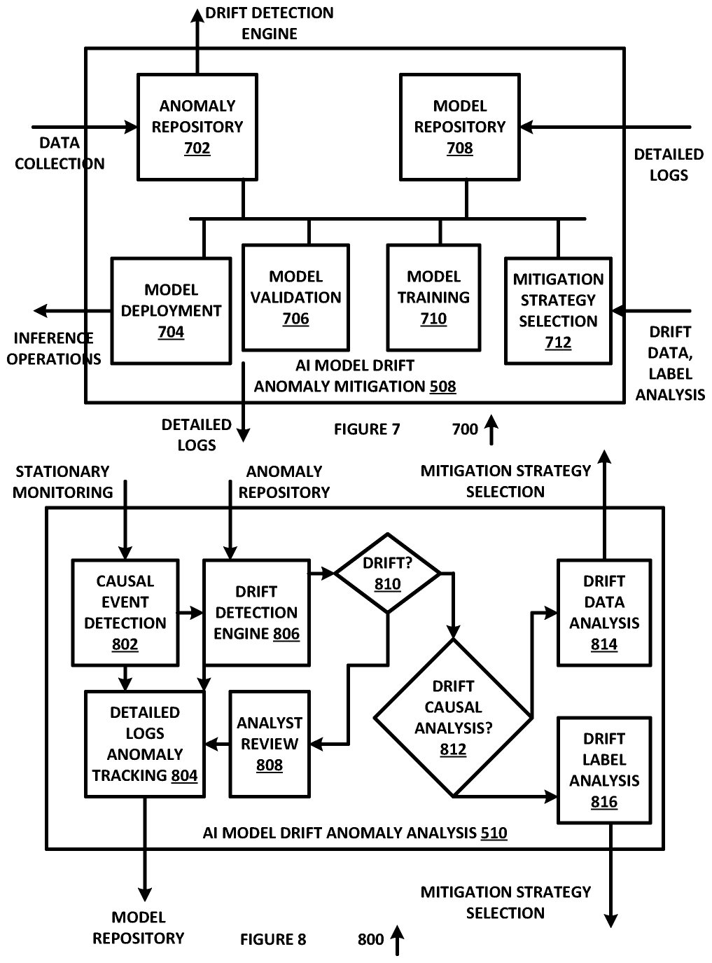

FIG. 7 is a system 700 for anomaly mitigation for drift analysis, in accordance with an example embodiment of the present disclosure. System 700 includes anomaly mitigation 508 and anomaly repository 702, model deployment 704, model validation 706, model repository 708, model training 710 and mitigation strategy selection 712, each of which can be implemented in hardware or a suitable combination of hardware and software.

Anomaly repository 702 can be implemented as one or more algorithms loaded from a data memory device into working memory of a processor, which cause the processor to perform perception anomaly data metadata repository searching, storing and processing. In one example embodiment, anomaly repository 702 can be configured to receive data from on-demand data collection 602, to determine whether the data contains anomalies and to generate an output to drift detection engine 806 to perform drift detection processing in response to detected anomalies, or other suitable functions.

Model deployment 704 can be implemented as one or more algorithms loaded from a data memory device into working memory of a processor, which cause the processor to perform model deployment processing, such as to deploy a new AI model or for other suitable purposes. In one example embodiment, model deployment 704 can receive a validated AI model from model validation 706 and can deploy the validated model to inference operations 606 or other suitable systems.

Model validation 706 can be implemented as one or more algorithms loaded from a data memory device into working memory of a processor, which cause the processor to perform AI model validation to correct for detected drift or other suitable functions. In one example embodiment, model validation 706 can receive AI model data from model repository 708 and model training data from model training 710 and can validate the model, such as by providing scoring data to model training 710, and by iteratively interfacing with model training 710 to obtain data sets, data streams and data classification, for additional data collection and data characterization, to obtain or update bias algorithm parameters, to obtain scoring errors, for versioning or for other suitable functions.

Model repository 708 can be implemented as one or more algorithms loaded from a data memory device into working memory of a processor, which cause the processor to perform model repository storage and retrieval and associated processing. In one example embodiment, model repository 708 can receive and process data sets, data streams and data classification associate with AI models to correct for drift, can process additional data collection and data characterization that is associated with AI models to correct for drift, to obtain or update bias algorithm parameters to correct drift in AI models, to obtain scoring errors for determining and assessing drift, for versioning of models and for other suitable purposes. Model repository 708 can be configured to receive data from detailed logs of anomaly tracking 804, mitigation strategy selection 712 and model validation 706, to provide data to model training 710 and mitigation strategy selection 712 and to perform other suitable functions.

Model training 710 can be implemented as one or more algorithms loaded from a data memory device into working memory of a processor, which cause the processor to perform AI model training to correct for drift or other suitable functions. In one example embodiment, model training 710 can receive data from model repository 708, mitigation strategy selection 712, model validation 706, anomaly repository 702 or other suitable data and can provide data to mitigation strategy selection 712, model validation 706 and other suitable systems, for AI model training to correct for drift.

Mitigation strategy selection 712 can be implemented as one or more algorithms loaded from a data memory device into working memory of a processor, which cause the processor to perform mitigation strategy selection for correcting AI models for drift. In one example embodiment, mitigation strategy selection 712 can provide mitigation strategy selection data to model repository 708, model training 710 and other suitable systems.

FIG. 8 is a system 800 for anomaly analysis for drift analysis, in accordance with an example embodiment of the present disclosure. System 500 includes anomaly analysis 510 and causal event detection 802, detailed logs anomaly tracking 804, drift detection engine 806, analyst review 808, drift decision block 810, drift causal analysis decision block 812, drift data analysis 814 and drift label analysis 816, each of which can be implemented in hardware or a suitable combination of hardware and software.

Causal event detection 802 can be implemented as one or more algorithms loaded from a data memory device into working memory of a processor, which cause the processor to perform causal event detection in data received from stationary monitoring 608 or other suitable data. In one example embodiment, stationary monitoring 608 can generate data that indicates that a causal event has occurred, and causal event detection 802 can generate an output that is received by drift detection engine 806 and data that is provided to detailed logs anomaly tracking 804.

Detailed logs anomaly tracking 804 can be implemented as one or more algorithms loaded from a data memory device into working memory of a processor, which cause the processor to perform detailed logs of anomaly tracking for drift detection, or other suitable functions. In one example embodiment, detailed logs anomaly tracking 804 can receive data from causal event detection 802, drift detection engine 806, analyst review 80 or other suitable data, and can generate data for model repository 708 or other suitable data.

Drift detection engine 806 can be implemented as one or more algorithms loaded from a data memory device into working memory of a processor, which cause the processor to perform drift detection in response to data received from anomaly repository 702, causal event detection 802 or other suitable data. In one example embodiment, drift detection engine 706 can determine whether drift has occurred that renders an AI model inaccurate, and can generate an output to drift decision block 810, detailed logs anomaly tracking 804 or other suitable data.

Analyst review 808 can be implemented as one or more algorithms loaded from a data memory device into working memory of a processor, which cause the processor to perform analyst review notification, tracking and other suitable functions. In one example embodiment, analyst review 808 can generate a notification to an analyst when AI model drift has been detected, can track the resolution or analysis of drift by the analyst and can perform other suitable functions. Analyst review 808 can generate output data for detailed logs anomaly tracking 804 or other suitable data.

Drift decision block 810 can be implemented as one or more algorithms loaded from a data memory device into working memory of a processor, which cause the processor to perform a drift decision process. In one example embodiment, drift decision block 810 can receive data from drift detection engine 806 and determine whether the data indicates that manual review is needed, that drift causal analysis is needed or that other processing is needed. If it is determined that manual review is needed, drift decision block 806 can generate data for analyst review 806, whereas if it is determined that drift causal analysis is needed, data can be generated for drift causal analysis decision block 812.

Drift causal analysis decision block 812 can be implemented as one or more algorithms loaded from a data memory device into working memory of a processor, which cause the processor to select drift data analysis 814, drift label analysis 816 or other suitable processes. In one example embodiment, drift data analysis 814 can be selected if drift data is present, and drift label analysis 816 can be selected if drift label analysis is needed.

Drift data analysis 814 can be implemented as one or more algorithms loaded from a data memory device into working memory of a processor, which cause the processor to perform drift data analysis processing. In one example embodiment, when drift is present, drift data analysis can be performed to identify one or more conditions that can be used to detect drift.

Drift label analysis 816 can be implemented as one or more algorithms loaded from a data memory device into working memory of a processor, which cause the processor to perform drift label analysis processing. In one example embodiment, when drift is present, drift label analysis can be performed to identify one or more labels that can be used to detect drift.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications, on one or more processors (where a processor includes one or more microcomputers or other suitable data processing units, memory devices, input-output devices, displays, data input devices such as a keyboard or a mouse, peripherals such as printers and speakers, associated drivers, control cards, power sources, network devices, docking station devices, or other suitable devices operating under control of software systems in conjunction with the processor or other devices), or other suitable software structures. In one exemplary embodiment, software can include one or more lines of code or other suitable software structures operating in a general purpose software application, such as an operating system, and one or more lines of code or other suitable software structures operating in a specific purpose software application. As used herein, the term “couple” and its cognate terms, such as “couples” and “coupled,” can include a physical connection (such as a copper conductor), a virtual connection (such as through randomly assigned memory locations of a data memory device), a logical connection (such as through logical gates of a semiconducting device), other suitable connections, or a suitable combination of such connections. The term “data” can refer to a suitable structure for using, conveying or storing data, such as a data field, a data buffer, a data message having the data value and sender/receiver address data, a control message having the data value and one or more operators that cause the receiving system or component to perform a function using the data, or other suitable hardware or software components for the electronic processing of data.

In general, a software system is a system that operates on a processor to perform predetermined functions in response to predetermined data fields. A software system is typically created as an algorithmic source code by a human programmer, and the source code algorithm is then compiled into a machine language algorithm with the source code algorithm functions, and linked to the specific input/output devices, dynamic link libraries and other specific hardware and software components of a processor, which converts the processor from a general purpose processor into a specific purpose processor. This well-known process for implementing an algorithm using a processor should require no explanation for one of even rudimentary skill in the art. For example, a system can be defined by the function it performs and the data fields that it performs the function on. As used herein, a NAME system, where NAME is typically the name of the general function that is performed by the system, refers to a software system that is configured to operate on a processor and to perform the disclosed function on the disclosed data fields. A system can receive one or more data inputs, such as data fields, user-entered data, control data in response to a user prompt or other suitable data, and can determine an action to take based on an algorithm, such as to proceed to a next algorithmic step if data is received, to repeat a prompt if data is not received, to perform a mathematical operation on two data fields, to sort or display data fields or to perform other suitable well-known algorithmic functions. Unless a specific algorithm is disclosed, then any suitable algorithm that would be known to one of skill in the art for performing the function using the associated data fields is contemplated as falling within the scope of the disclosure. For example, a message system that generates a message that includes a sender address field, a recipient address field and a message field would encompass software operating on a processor that can obtain the sender address field, recipient address field and message field from a suitable system or device of the processor, such as a buffer device or buffer system, can assemble the sender address field, recipient address field and message field into a suitable electronic message format (such as an electronic mail message, a TCP/IP message or any other suitable message format that has a sender address field, a recipient address field and message field), and can transmit the electronic message using electronic messaging systems and devices of the processor over a communications medium, such as a network. One of ordinary skill in the art would be able to provide the specific coding for a specific application based on the foregoing disclosure, which is intended to set forth exemplary embodiments of the present disclosure, and not to provide a tutorial for someone having less than ordinary skill in the art, such as someone who is unfamiliar with programming or processors in a suitable programming language. A specific algorithm for performing a function can be provided in a flow chart form or in other suitable formats, where the data fields and associated functions can be set forth in an exemplary order of operations, where the order can be rearranged as suitable and is not intended to be limiting unless explicitly stated to be limiting.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for processing data comprising:
an artificial intelligence (AI) model operating on a processor and configured to process an incoming data set to generate a data output;
an AI model anomaly detection system operating on the processor and configured to receive the incoming data set and the data output and to generate an anomaly detection as a function of the incoming data set and the data output;
an AI model anomaly analysis system operating on the processor and configured to receive the anomaly detection and the incoming data set and to generate AI model anomaly data; and
an AI model anomaly mitigation system operating on the processor and configured to receive the AI model anomaly data and to generate AI model anomaly correction data.

2. The system of claim 1 wherein the AI model anomaly detection system comprises an on-demand data collection system operating on the processor and configured to generate a request for data collection on demand in response to the incoming data set.

3. The system of claim 1 wherein the AI model anomaly detection system comprises a perception classification system operating on the processor and configured to generate perception classification data in response to the incoming data set.

4. The system of claim 1 wherein the AI model anomaly detection system comprises an inference operations system operating on the processor and configured to receive perception classification data and to generate inference data.

5. The system of claim 1 wherein the AI model anomaly detection system comprises a stationary monitoring system operating on the processor and configured to receive inference data and to generate stationary monitoring output data.

6. The system of claim 1 wherein the AI model anomaly analysis system comprises a causal event detection system operating on the processor and configured to receive stationary monitory data and to generate causal event detection data.

7. The system of claim 1 wherein the AI model anomaly analysis system comprises a detailed logs anomaly tracking system operating on the processor and configured to receive causal event detection data and to generate detailed logs anomaly tracking data.

8. The system of claim 1 wherein the AI model anomaly analysis system comprises a drift detection engine operating on the processor and configured to receive causal event detection data and to generate drift detection data.

9. The system of claim 1 wherein the AI model anomaly analysis system comprises an analyst review system operating on the processor and configured to receive drift decision block output data and to generate analyst review data.

10. The system of claim 1 wherein the AI model anomaly analysis system comprises a drift decision block operating on the processor and configured to receive drift detection data and to generate a drift decision output.

11. The system of claim 1 wherein the AI model anomaly analysis system comprises a drift causal analysis decision block operating on the processor and configured to receive drift decision output data and to generate drift causal analysis output data.

12. The system of claim 1 wherein the AI model anomaly analysis system comprises drift data analysis system operating on the processor and configured to receive drift causal analysis output data and to generate drift data analysis output data.

13. The system of claim 1 wherein the AI model anomaly analysis system comprises a drift label analysis system operating on the processor and configured to receive drift causal analysis output data and to generate drift label analysis output data.

14. The system of claim 1 wherein the AI model anomaly mitigation system comprises an anomaly repository operating on the processor and configured to receive on-demand data collection and to generate drift detection engine data.

15. The system of claim 1 wherein the AI model anomaly mitigation system comprises a model deployment system operating on the processor and configured to generate inference operations output data that includes a new AI model.

16. The system of claim 1 wherein the AI model anomaly mitigation system comprises a model repository operating on the processor and configured to store a plurality of AI models.

17. The system of claim 1 wherein the AI model anomaly mitigation system comprises a model validation system operating on the processor and configured to receive AI model data and to generate detailed log data.

18. The system of claim 1 wherein the AI model anomaly mitigation system comprises a model training system operating on the processor and configured to receive AI model data and to generate AI model training data.

19. The system of claim 1 wherein the AI model anomaly mitigation system comprises a mitigation strategy selection system operating on the processor and configured to receive drift data and label analysis data and to generate mitigation strategy selection data.
